(19) United States
(12) Patent Application Publication
(10) Pub. No.: US 2011/0040735 A1
(43) Pub. Date: Feb. 17, 2011

(54) SYSTEM AND METHOD FOR COMPRESSING FILES

(75) Inventors: CHUNG-I LEE, Tu-Cheng (TW); CHIEN-FA YEH, Tu-Cheng (TW); SHAN-CHUAN JENG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/646,890

(22) Filed: Dec. 23, 2009

(30) Foreign Application Priority Data
Aug. 13, 2009 (CN) 200910305574.9

(51) Int. Cl. G06F 17/30

(52) U.S. Cl. 707/693; 707/E17.002

(57) ABSTRACT

A system and method for compressing files obtains a file to be compressed, divides the file into different sections. The system and method further compresses each section with an image compression algorithm or a text compression algorithm according a type of each section, and connects all compressed sections to obtain a compressed file.

### BACKGROUND

1. Technical Field

Embodiments of the present disclosure relate to file processing technology, and particularly to a system and method for compressing files.

2. Description of Related Art

Currently, a file may be compressed using a single compression algorithm, such as an image compression algorithm or a text compression algorithm. However, if the file is compressed using the image compression algorithm, compression efficiency of text in the file is low, and a size of the file being compressed would be too big. If the file is compressed using the text compression algorithm, compression efficiency of the texts in the file may be increased, but images in the file are converted to binary images, causing definitions of the images in the file to be degraded. Therefore, prompt and efficient method for compressing files is desired.

### BRIEF DESCRIPTION OF THE DRAWINGS

FIG. 1 is a block diagram of one embodiment of a computer comprising a file compressing system for comprising files.

FIG. 2 is a flowchart of one embodiment of a method for comprising files.

FIG. 3 is a schematic diagram of one embodiment of a method for dividing a file into different types of blocks.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

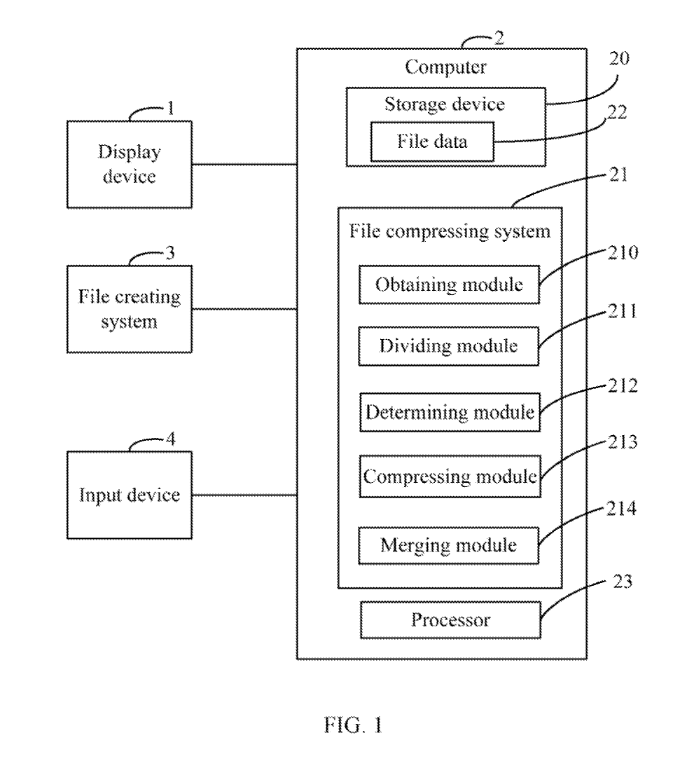

FIG. 1 is a block diagram of one embodiment of a computer 2 comprising a file compressing system 21. In one embodiment, the file compressing system 21 may be used to compress files using different compression algorithms. A detailed description will be given in the following paragraphs.

In one embodiment, the computer 2 is electronically connected to a display device 1, a file creating system 3, and an input device 4. Depending on the embodiment, the display device 1 may be a liquid crystal display (LCD) or a cathode ray tube (CRT) display, for example.

The computer 2 further includes a storage device 20 for storing information, such as file data 22 created by the file creating system 3. In one embodiment, the file data 22 may include images and text.

The input device 4 may be used for manual editing of a file displayed on the display device 1. In one embodiment, the input device 4 may be a keyboard.

In one embodiment, the file compressing system 21 includes an obtaining module 210, a dividing module 211, a determining module 212, a compressing module 213, and a merging module 214. In one embodiment, the modules 210-214 comprise one or more computerized instructions that are stored in the storage device 20. A processor 23 of the computer 2 executes the computerized instructions to implement one or more operations of the computer 2.

The obtaining module 210 obtains a file to be compressed from the storage device 20.

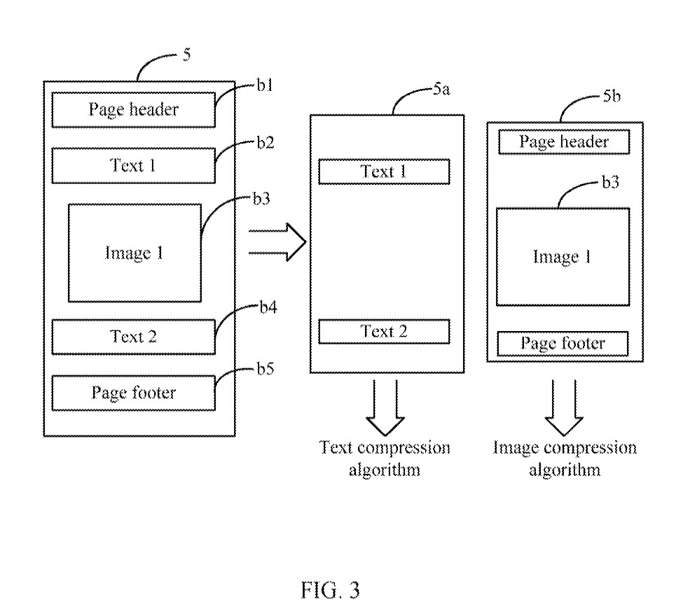

The dividing module 211 divides the file into different sections. In one embodiment, types of the different sections include at least an image section and a text section. Referring to FIG. 3, a file 5 (including only one page) to be compressed is divided into five sections: b1, b2, b3, b4, and b5, where sections b1, b3, and b5 are image sections, and sections b2 and b4 are text sections. In an other embodiment, a section of the file is also represented by a slice of the file, where each paragraph in the file is regarded as one section. In one embodiment, the image section may include one or more images, and the text section may include a body of a text.

The determining module 212 determines a type of each section. In one embodiment, the determining module 212 determines a section is the image section if a number of color pixels in the section is greater than or equal to a preset threshold value (e.g., a half total number of pixels in the section). Otherwise, the determining module 212 determines a section is the text section if a number of color pixels in the section is less than the preset threshold value.

The compressing module 213 compresses a section with an image compression algorithm if the section is the image section (refer to 5b of FIG. 3). In one embodiment, the image compression algorithm may be a DCT-based (e.g., joint photographic experts group, JPEG) compression algorithm or Wavelet-based (e.g. JPEG2000) compression algorithm.

The compressing module 213 compresses the section with a text compression algorithm if the section is the text section (refer to 5a of FIG. 3). In one embodiment, the text compression algorithm may be a fax encoding algorithm, such as CCITT Group 3 or CCITT Group 4, and the section compressed by the text compression algorithm is a binary image. It may be understood that the binary image has only two possible values for each pixel in the binary image. Usually, two colors used for the binary image are black and white, although any two colors can be used. In one embodiment, the color used for the object in the image is the foreground color (such as black), while the rest of the image is the background color (such as white).

The merging module 214 connects all compressed sections to obtain a compressed file.

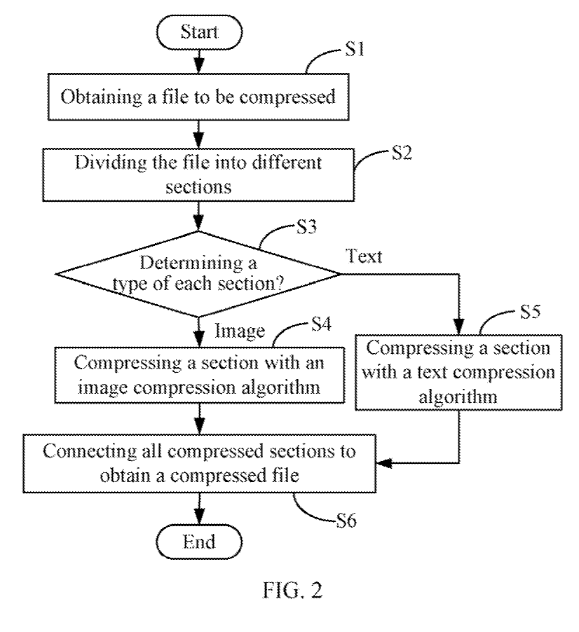

FIG. 2 is a flowchart of one embodiment of a method for compressing files. Depending on the embodiment, additional blocks may be added, others removed, and the ordering of the blocks may be changed.

In block S1, the obtaining module 210 obtains a file to be compressed from the storage device 20.

In block S2, the dividing module 211 divides the file into different sections. In one embodiment, types of the different sections include at least an image section and a text section. Referring to FIG. 3, a file 5 to be compressed is divided into five sections: b1, b2, b3, b4, and b5, where sections b1, b3, and b5 are image sections, and sections b2 and b4 are text sections.

In block S3, the determining module 212 determines a type of each section. The procedure goes to block S4 if the section is the image section. Otherwise, the procedure goes to block S5 if the section is the text section. In one embodiment, the determining module 212 determines a section is the image section if a number of color pixels in the section is greater than or equal to a preset threshold value. Otherwise, the determining module 212 determines a section is the text section if a number of color pixels in the section is less than the preset threshold value.

In block S4, the compressing module 213 compresses a section with an image compression algorithm (refer to 5b of FIG. 3). In one embodiment, the image compression algorithm may be a DCT-based (e.g., joint photographic experts group, JPEG) compression algorithm or Wavelet-based (e.g. JPEG2000) compression algorithm.

In block S5, the compressing module 213 compresses the section with a text compression algorithm (refer to 5a of FIG. 3). In one embodiment, the text compression algorithm may be a fax encoding algorithm, such as CCITT Group 3 or CCITT Group 4, and the section compressed by the text compression algorithm is a binary image.

In block S6, the merging module 214 connects all compressed sections to obtain a compressed file. In one embodiment, the merging module 214 obtains a header of each page, connects each compressed section belong to a same page according to the header of the page, and connects all pages to obtain the compressed file.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented file compression method, comprising:
obtaining a file from a storage device;
dividing the file into different sections, wherein types of the different sections comprise at least an image section and a text section;
determining a type of each of the different sections, and compressing each of the different sections with an image compression algorithm if the type of the section is the image section, or compressing each of the different sections with a text compression algorithm if the type of the section is the text section; and
connecting all compressed sections to obtain a compressed file.

2. The method according to claim 1, wherein determining a type of each of the different sections comprises:
determining one section is the image section if a number of colorized pixels in the one section is greater than or equal to a preset threshold value; or
determining the one section is the text section if a number of colorized pixels in the one section is less than the preset threshold value.

3. The method according to claim 1, wherein the image compression algorithm is a DCT-based compression algorithm or Wavelet-based compression algorithm.

4. The method according to claim 1, wherein the text compression algorithm is a fax encoding algorithm.

5. The method according to claim 4, wherein the sections compressed by the text compression algorithm are binary images.

6. A storage medium having stored thereon instructions that, when executed by a processor of a computer, cause the processor to perform a method for comprising files, the method comprising:
obtaining a file from a storage device;
dividing the file into different sections, wherein types of the different sections comprise at least an image section and a text section;
determining a type of each of the different sections, and compressing each of the different sections with an image compression algorithm if the type of the section is the image section, or compressing each of the different sections with a text compression algorithm if the type of the section is the text section; and
connecting all compressed sections to obtain a compressed file.

7. The storage medium according to claim 6, wherein determining a type of each of the different sections comprises:
determining one section is the image section if a number of colorized pixels in the one section is greater than or equal to a preset threshold value; or
determining the one section is the text section if a number of colorized pixels in the one section is less than the preset threshold value.

8. The storage medium according to claim 6, wherein the image compression algorithm is a DCT-based compression algorithm or Wavelet-based compression algorithm.

9. The storage medium according to claim 6, wherein the text compression algorithm is a fax encoding algorithm.

10. The storage medium according to claim 9, wherein the sections compressed by the text compression algorithm are binary images.

11. The storage medium according to claim 6, wherein the medium is selected from the group consisting of a hard disk drive, a compact disc, a digital video disc, and a tape drive.

12. A computing system for comprising files, comprising:
a storage device for storing files created by a file creating system;
an obtaining module operable to obtain a file from the storage device;
a dividing module operable to divide the file into different sections, wherein types of the different sections comprise at least an image section and a text section;
a determining module operable to determine a type of each of the different sections;
a compressing module operable to compress each of the different sections with an image compression algorithm if the type of the section is the image section;
the compressing module further operable to compress each of the different sections with a text compression algorithm if the type of the section is the text section; and
a merging module operable to connect all compressed sections to obtain a compressed file.

13. The system according to claim 12, wherein the determining module determines a type of each of the different sections by:
determining one section is the image section if a number of colorized pixels in the one section is greater than or equal to a preset threshold value; or
determining the one section is the text section if a number of colorized pixels in the one section is less than the preset threshold value.

14. The system according to claim 12, wherein the image compression algorithm is a DCT-based compression algorithm or Wavelet-based compression algorithm.

15. The system according to claim 12, wherein the text compression algorithm is a fax encoding algorithm.

16. The system according to claim 15, wherein the sections compressed by the text compression algorithm are binary images.
